(19) United States
(12) Patent Application Publication
(10) Pub. No.: US 2016/0033096 A1
(43) Pub. Date: Feb. 4, 2016

(54) Divali string of light Om and deya arrangement

(71) Applicant: Aartee S. Satyaketu, Pembroke Pines, FL (US)

(72) Inventor: Aartee S. Satyaketu, Pembroke Pines, FL (US)

(21) Appl. No.: 14/121,089

(22) Filed: Jul. 30, 2014

(51) Int. Cl. F21S 4/00; F21V 23/06; F21S 9/03

(52) U.S. Cl. CPC F21S 4/001; F21S 9/032; F21V 23/06; F21W 2121/00

(57) ABSTRACT

The present invention relates to an electrically powered ornamental lamp arrangement for interior or exterior lighting display which includes a main electrical supply string and one or more electrically wired light emitting lamp ornaments or religious symbols electrically and detachably connected to the main supply string. The ornamental lamp arrangement may further include one or more light emitting sources electrically connected to the main supply string. The ornamental lamp arrangement is constructed for display in celebration of the Hindu Divali light holiday, the ornamental lamp arrangement particularly constructed in the form of the Hindu Om syllable symbol and Hindu deya likenesses.

### BACKGROUND OF THE INVENTION AND PRIOR ART

The invention relates to an ornamental lighting lamp arrangement for interior or exterior display for the Divali light festival of the Hindu faith. The ornamental lighting lamp arrangement includes a string of detachably connected electrically wired light emitting decorations in the shapes of the Hindu Om symbol and the likeness of a deya lamp. The ornamental lighting lamp arrangement is constructed so it may be hung from a ceiling or elevated structure or displayed on the ground in celebration of the Hindu Divali religious festival and associated occasions.

The limitations of the prior art in this area suggests the need for such an ornamental lighting lamp arrangement for use in the Hindu Divali religious festival.

U.S. Pat. No. 4,977,488 issued Dec. 11, 1990 to Spotts et al. teaches a solar powered outdoor recreational light with positionable solar panel comprising a lamp illuminated by solar panel mounted in an articulatable housing. The system, however, lacks any adaptation or construction for use for the Hindu Divali festival or celebration nor for the use or display of the Om symbol or a deya lamp likeness.

U.S. Pat. No. 5,379,202 issued Jan. 3, 1995 to Dann teaches an outdoor animated holiday light display comprising overlapping display elements with light string sets arranged and sequence to produce an animated effect. The display likewise lacks any adaptation or construction for exhibiting an Om symbol, a deya lamp likeness or other Hindu Divali festival symbols.

U.S. Pat. No. 7,878,685 issued Feb. 1, 2011 to Wang teaches a lighting fixture structured for various holiday displays comprising a plurality of light bulbs mounted on a frame constructed by a plurality of contoured rods which produce a refracting effect from the light bulbs. The fixture, however, is without any provision, adaptation or construction for Hindu Divali festival effects such as an Om symbol or deya lamp likeness.

U.S. Patent Published Application No. 2009/0268444 A1 published on Oct. 29, 2009 to Fair et al is a published utility patent application disclosing a decorative lighting array for indoor or outdoor display but similarly lacks any ornamentation for use in a Hindu Divan festival specifically displaying any Om symbols or deya lamp likenesses.

### SUMMARY OF THE INVENTION

It is typical for people to ornament or accessorize their homes, offices, and other locations for festive occasions such as religious holidays including the Hindu festival of light also known as Divali. Such lamp arrangements elevate the festive atmosphere surrounding these holiday celebrations and allow people to express their imagination and artistry. Increasing, around the world, light lamp arrangements continue to gain popularity and such light lamp arrangements are used both for indoor and outdoor displays. Usually, these light lamp arrangements include a string of electrically powered lights or decorations spaced at intervals along the string. Many people, as an example, to celebrate Christmas hang strings of lights on the exterior of their homes while others, of different religions around the world, use strings of lights to celebrate their particular religion. However, the Hindu community is underserved as there are virtually a total lack of decorative light assemblies which are intended to be used in connection with the celebration of the Hindu “festival of lights”; additionally, there is a virtual lack of any decorative light assemblies displaying the likeness of the Hindu syllable symbol Om or a deya lamp.

A five-day Hindu festival, Divali also known as Diwali, is one of the most important festivals of the year for Hindus and is popularly known as the “festival of lights”. It is celebrated by families by performing traditional activities together in their homes in which all the celebrants wear new cloths, share sweets and snacks with family members and friends. The name “Divali” is a contraction which translates into “row of lamps” and involves the lighting of small clay lamps filled with oil to signify the triumph of good over evil. During the night, these lamps remain lit while family members clean their house, both activities performed in order to make the goddess Lakshmi feel welcome. Sometimes, during Divali, firecrackers may be burst in a belief of driving away evil spirits.

Of particular significance and importance for a Divali festival is the Om and symbol which is the supreme and most sacred syllable in Hinduism. Consisting in Sanskrit of the three sounds (a), (u), and (m), Om is sounded together and believed to be the spoken essence of the universe. It is uttered as a mantra, in affirmations and blessings in Hindu ceremonies; Om, also denoted as AUK, is sounded by humming, or chanting in various Hindu readings, prayers, or ceremonies usually at the beginning and end of the reading, etc. Om is also evoked as an invitation to a Hindu god or deity being prayed to, i.e., Vishnu, Brahma, or Shiva, to partake of the reading, etc. Additionally, Om is often sounded during various Yoga meditation exercises to induce a sense of calmness, peacefulness and relaxation. Om is written in various Hindu skrits but universally in the Indian Devanagari skrit as [symbol] which denotes the three times as long length of sounding of the syllables a, u, and m in an overlong, nasalized rounded vowel.

A deya, also known a diya, is a type of oil lamp, traditionally made of clay, comprising a cotton wick dipped or soaked in various oils such as a vegetable oil or ghee and during the Divali celebration, the lamps are lit. Native to India, deyas are used very often in the Divali light festival; although usually made of clay, other types of earthenware pots can be used and although the pots or deya may be constructed for temporary use, more substantial deyas are made of brass or similar longer lasting material. The present invention relates to a decorative light lamp arrangement that includes a main electrical string and connections for electrically connecting interchangeable components to the electrical string, thereby providing a decorative light lamp arrangement that is structured for use with the Divali festival of lights. The present invention is also structured so it may be hung from a ceiling or elevated structure or displayed on the ground. Specifically, the present invention relates to closed lighting lamp arrangement incorporating the likenesses of the Hindu Om, also known as AUM, with the symbol [symbol] , as written in the Devanagari skrit which is the symbol of the Hindu religion and also of a deya lamp.

The invention provides for an electrically wired light emitting ornament lamp arrangement comprising a base, electrical wiring attached to said base, a light emitting source in electrical connection with said electrical wiring, and a connector for connecting said ornament lamp arrangement to a source of electricity wherein the ornament in constructed in the form of an OM syllable symbol [symbol] and a deya lamp likeness.

A decorative lamp arrangement or display is also provided, the decorative lamp arrangement comprising an elongated electrical string and at least one electrically wired and detachably connected light emitting ornament pendant from said string wherein the pendant is constructed in the form of an Om syllable symbol, i.e., [symbol] or alternatively, the likeness of a deya lamp.

According to certain embodiments, the decorative lighting lamp arrangement comprises an elongated electrical string having at least one connector adapted for electrically connecting an electrically wired ornament to said electrical string; and at least one electrically wired light emitting ornament electrically and detachably connected to said electrical string wherein the ornament in constructed in the form of an Om syllable symbol [symbol] or alternatively, a deya lamp likeness.

According to other embodiments, a decorative lighting lamp arrangement is provided, the decorative lighting lamp arrangement comprising a string of electrically connected lights, and at least one electrically wired light emitting ornament electrically and detachably connected to said string particularly wherein the ornament in constructed in the form of an Om syllable symbol [symbol] or alternatively, a deya lamp likeness.

A decorative lighting lamp arrangement kit is also provided, said kit comprising an electrical string of electrically connected receptacles; and at least one of (i) a plurality of light emitting ornaments adapted for electrical connection with at least one of said electrically connected receptacles, or (ii) a combination of (a) a plurality of light emitting ornaments adapted for electrical connection with at least one of said electrical connectors and (b) a plurality of different colored light emitting sources adapted for electrical connection with at least one of said electrical connectors and (c) wherein the ornaments are constructed by the use of electrical illuminable tear drop shaped bulbs in the form of an Om syllable symbol [symbol] and the likeness of a deya lamp.

A decorative lamp arrangement or display is also provided, the decorative lamp arrangement comprising an elongated electrical string and at least one electrically wired and detachably connected light emitting ornament pendant from said string wherein the pendant is constructed by the use of electrical illuminable tear drop shaped bulbs in the form of constructed in the form of an Om and syllable symbol, i.e., [symbol] or in the form of the likeness of a deya lamp wherein the lamp arrangement is further constructed with fasteners to facilitate the lamp arrangement from being hung from a ceiling or elevated structures.

According to other embodiments, a decorative lighting lamp arrangement is provided, the decorative lighting lamp arrangement comprising a string of electrically connected lights, and at least one electrically wired light emitting ornament electrically and detachably connected to said string particularly wherein the ornament in constructed in the form of an Om syllable symbol [symbol] or alternatively in the likeness of deya lamp and further wherein the lamp arrangement is structured for exterior use and also being particularly provided with a solar powered energy source and is further constructed with fasteners to facilitate the lamp arrangement from being hung from a ceiling or elevated structure.

According to other embodiments, a decorative lighting lamp arrangement is provided, the decorative lighting lamp arrangement comprising a string of electrically connected lights, and at least one electrically wired light emitting ornament electrically and detachably connected to said string particularly wherein the ornament in constructed by the use of electrical illuminable tear drop shaped bulbs in the form of an Om syllable symbol [symbol] alternatively in the likeness of a deya lamp and where the lamp arrangement is structured for exterior use being particularly provided with a solar powered energy source and is further constructed to enable the lamp arrangement to be mounted on the ground.

Thus been outlined, rather broadly, the more important features of a Divali string of light Om syllable symbol and deya lamp likeness lamp arrangement, as discussed in the detailed description that follows, may be better understood and in order that the present contribution to the art may be better appreciated. There are, of course, additional features of the Divali string of light Om syllable symbol and deya lamp likeness lamp arrangement that will be described hereinafter and which will form the subject matter of the claims appended hereto.

In this respect, before explaining at least one embodiment of the Divali string of light Om syllable symbol and deya lamp likeness lamp arrangement in detail, it is to be understood that the Divali string of light Om syllable symbol and deya lamp likeness lamp arrangement is not limited in its application to the details of construction and to the lamp arrangements of the components set forth in the following description or illustrated in the drawings. The Divali string of light Om syllable symbol and deya lamp likeness lamp arrangement is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the constructing of other structures, methods and systems for carrying out the several purposes of the present Divali string of light Om syllable symbol and deya lamp likeness lamp arrangement. It is important, therefore, that the claims be regarded as including such equivalent constructions insofar as they do not depart from the spirit and scope of the present invention.

Other objects, features and advantages of the present invention will become more readily apparent from the following detailed description of the preferred embodiment when considered with the attached drawings and appended claims.

When introducing elements of the present invention or the preferred embodiment(s) thereof, the articles “a”, “an”, “the”, and “said” are intended to mean there are one or more of the elements. The terms “comprising”, “including”, and “having” are intended to be inclusive and mean that there may be additional elements other than the listed elements.

### BRIEF DESCRIPTION OF THE DRAWINGS

FIG. 1 is a front elevation view of a deya lamp arrangement used in an elevated environment according to an exemplary embodiment of the present invention.

FIG. 1a is a front elevation view of a deya lamp arrangement used in an elevated environment according to another embodiment of the present invention.

FIG. 1b is a front elevation view of a deya lamp arrangement used in an elevated environment according to another embodiment of the present invention.

FIG. 2 is a front elevation view of an Om syllable symbol lamp arrangement used in an elevated environment according to an exemplary embodiment of the present invention.

FIG. 2a is a front elevation view of an Om syllable symbol lamp arrangement used in an elevated environment according to another embodiment of the present invention.

FIG. 2b is a front elevation view of an Om syllable symbol lamp arrangement used in an elevated environment according to another embodiment of the present invention.

FIG. 3 is a front elevation view of a deya and Om syllable symbol lamp arrangement used in a ground supported environment according to an exemplary embodiment of the present invention.

FIG. 3a is a front elevation view of a deya and Om syllable symbol lamp arrangement used in a ground supported environment according to another embodiment of the present invention.

FIG. 3b is a front elevation view of a deya and Om syllable symbol lamp arrangement used in a ground supported environment according to another embodiment of the present invention.

FIG. 4 is a detailed view of the lamp arrangement of FIGS. 1, 1a, and 1b.

FIG. 4a is a detailed view of the lamp arrangement of FIGS. 1, 1a, and 1b according to another embodiment of the present invention.

FIG. 5 is a detailed view of the lamp arrangement of FIGS. 2, 2a, and 2b.

FIG. 5a is a detailed view of the lamp arrangement of FIGS. 2, 2a, and 2b according to another embodiment of the present invention.

FIG. 6 is a detailed view of the deya and Om syllable symbol lamp arrangement of FIGS. 3, 3a, and 3b.

FIG. 6a is a detailed view of the deya and Om syllable symbol lamp arrangement of FIGS. 3, 3a, and 3b showing details of another embodiment of the deya lamp arrangement.

FIG. 6b is a detailed view of the deya and Om syllable symbol lamp arrangement of FIGS. 3, 3a, and 3b showing details of another embodiment of the Om syllable symbol lamp arrangement.

FIG. 7 is a detailed view of the deya lamp arrangement of FIGS. 1, 1a, and 1b showing further details of the deya lamp.

FIG. 7a is a top detailed view of the deya lamp arrangement of FIGS. 1, 1a, and 1b showing further details of the deya lamp.

FIG. 7b is a side detailed view of the deya lamp arrangement of FIGS. 1, 1a, and 1b showing further details of the deya lamp.

FIG. 7c is an exploded detailed view of the deya lamp arrangement of FIG. 7.

FIG. 8 is a detailed view of the deya lamp arrangement of FIGS. 1, 1a, and 1b showing further details of an another embodiment of the deya lamp.

FIG. 8a is a top detailed view of the deya lamp arrangement of FIGS. 1, 1a, and 1b showing further details of an another embodiment of the deya lamp.

FIG. 8b is a side detailed view of the deya lamp arrangement of FIGS. 1, 1a, and 1b, a showing further details of an another embodiment of the deya lamp.

FIG. 9 is a detailed view of the lamp arrangement of FIGS. 2, 2a, and 2b showing further details of an embodiment of the Om syllable symbol lamp.

FIG. 9a is a top detailed view of the lamp arrangement of FIGS. 2, 2a, and 2b showing further details of an embodiment of the Om syllable symbol lamp.

FIG. 9b is a side detailed view of the lamp arrangement of FIGS. 2, 2a, and 2b showing further details of an embodiment of the Om syllable symbol lamp.

FIG. 9c is an exploded detailed view of the Om syllable symbol lamp arrangement of FIG. 9.

FIG. 10 is a detailed view of the lamp arrangement of FIGS. 2, 2a, and 2b showing further details of another embodiment of the Om syllable symbol lamp

FIG. 10a is a top detailed view of the lamp arrangement of FIGS. 2, 2a, and 2b showing further details of an another embodiment of the Om syllable symbol lamp.

FIG. 10b is a side detailed view of the lamp arrangement of FIGS. 2, 2b, and 2b showing further details of another embodiment of the Om syllable symbol lamp.

### DETAILED DESCRIPTION

An illustrative embodiment of the Divali string of light Om syllable and deya lamp arrangement will now be described in further detail with reference to the drawing figures. It should be noted that the following described and disclosed Divali string of light Hindu Om syllable symbol and deya lamp arrangement may have more embodiments than those shown in the drawing figures and shall include all variations and modifications within the scope of the claims.

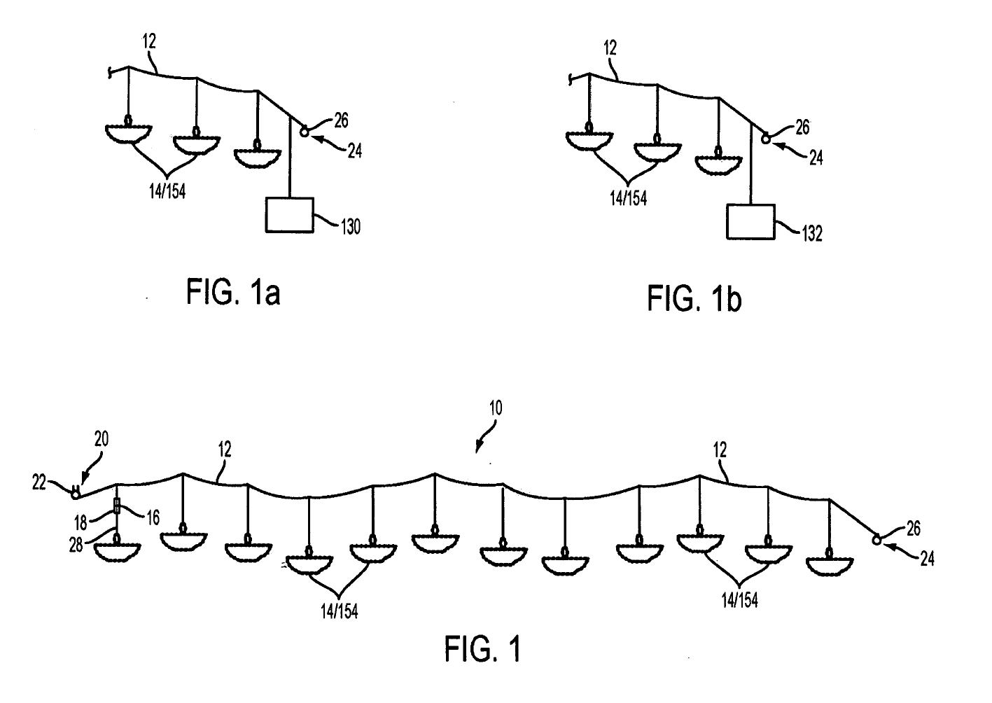

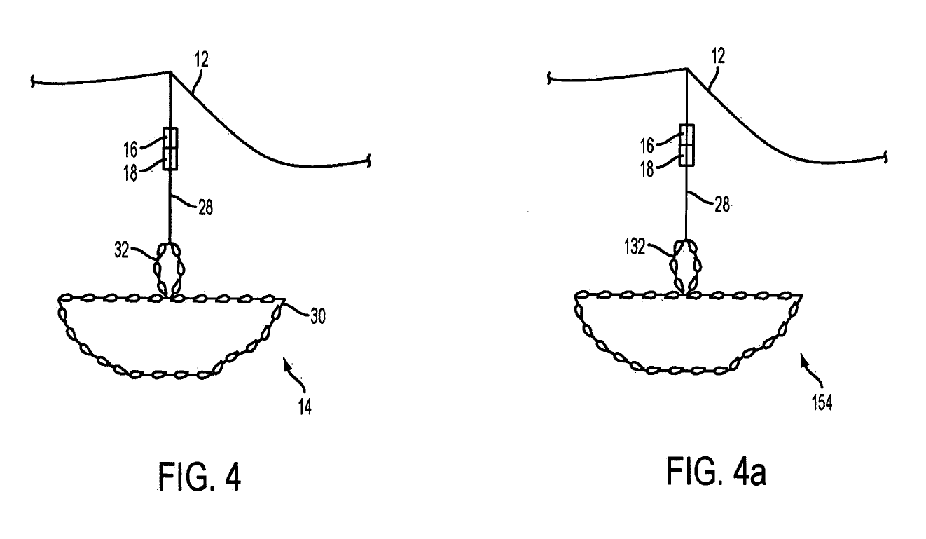

FIG. 1 shows an illustrative embodiment of the Divan string of light Hindu Om syllable symbol and deya lamp arrangement 10 which comprises an electrical supply string 12 capable of being connected to an electrical supply source and also electrically connected to light emitting lamp ornaments 14 or 154 which ornaments are discussed in detail in FIGS. 4, 7 and 8. Additionally, string 12 further comprises an elongated insulated electrical wire which includes electrical connectors 16 and 18 and electrical feed wire 28 that are adapted to receive and supply electrical energy to light emitting ornament elements 14 or 154. Additionally ornaments 14 or 154 are arranged in a spaced apart relationship along the electrical string 12. Although only one ornament 14 or 154 is shown in FIG. 1 as having connectors 16, 18, and feed wire 28, it is understood that each ornament 14 or 154 in the arrangement is provided with such connectors and feed wires in practice. Further arrangement 10 is shown in an elevated position and can be provided with various implements, e.g. hooks, hangers, etc. for attaching or hanging arrangement 10 from such a position.

Still referring to FIG. 1, string 12 is provided at one end 20 with an attachment plug element 22 for effecting interconnection of the string 12 to a source of electricity and/or to another string of light emitting ornaments. Additionally, string 12 is provided with a second end 24 having an attachment plug 26 that is adapted to effect interconnection of string 12 to another string of light emitting lamp ornaments.

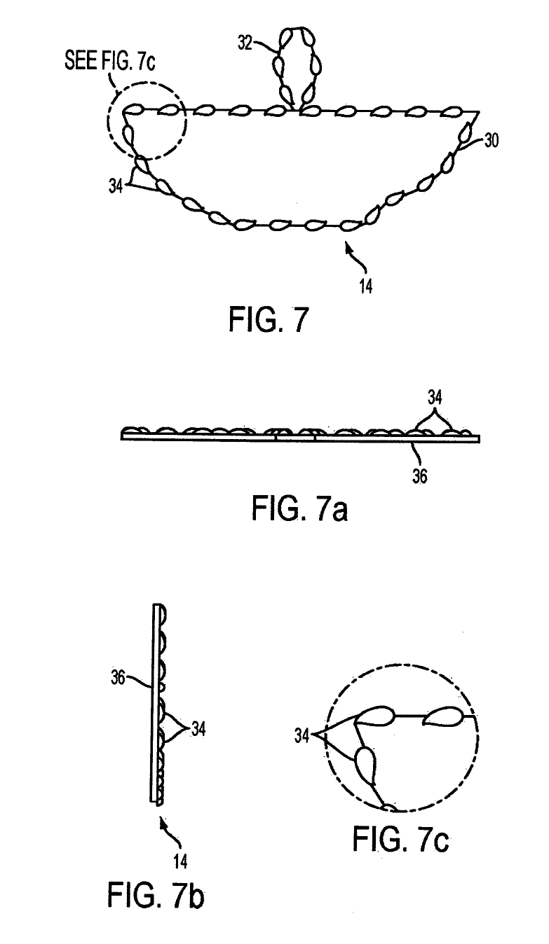

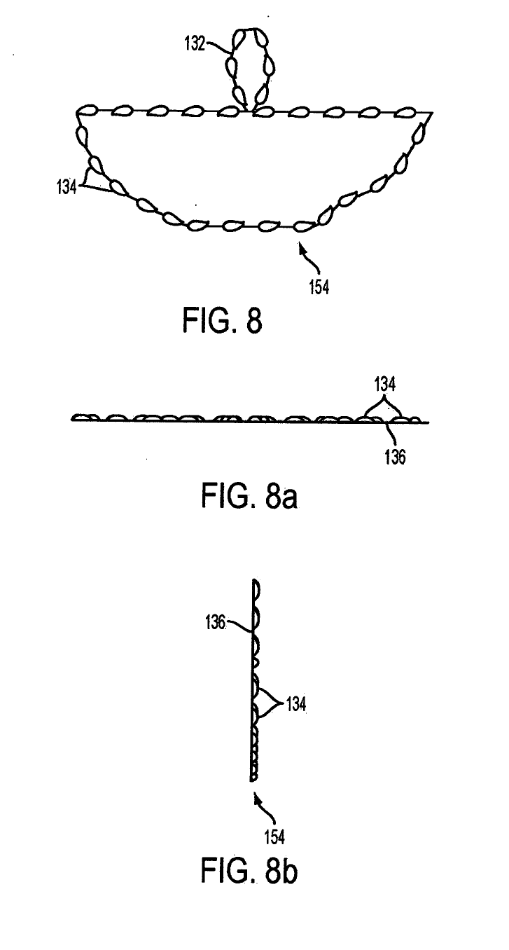

Further referring to FIG. 1, string 12 is provided with a plurality of light emitting lamp ornaments 14 or 154, and according to the illustrative embodiment shown in FIG. 1 these ornaments are in the likeness of a deya lamp. The deya likeness lamp ornament may consist of the deya lamp ornament 14 described and disclosed in further detail in FIGS. 4 and 7 or the deya lamp ornament 154 described and disclosed in further detail in FIGS. 4a and 8. Additionally, as previously described and disclosed, light emitting deya likeness lamp ornaments 14 or 154, are arranged at spaced apart intervals along string 12 and are individually electrically connected to string 12 via suitable connectors 16, 18 and feed wire 28.

FIG. 1a shows another embodiment of the Divali string of light Hindu Om syllable symbol and deya lamp arrangement 10 disclosed in FIG. 1 wherein an electrical battery source 130 is provided to supply electrical energy to string 12 of the light deya lamp likeness arrangement 10. The electrical battery source 130 may comprise any conventional commercial available devices and in this embodiment, attachment plug elements 22 and 26 would function to interconnect the string 12 to another or plurality of similar string of light emitting ornaments. Alternatively, battery source 130 can be attached to plug elements 22 or 26.

FIG. 1b shows another embodiment of the Divali string of light Hindu Om syllable symbol and deya lamp arrangement 10 disclosed in FIG. 1 wherein a solar electrical source 132 is provided to supply electrical energy to string 12 of the light deya lamp likeness arrangement 10. The solar electrical source 132 may comprise any conventional commercial available devices and in this embodiment, attachment plug elements 22 and 26 would function to interconnect the string 12 to another or plurality of string of light emitting ornaments. Alternatively, solar source 132 can be attached to plug elements 22 or 26.

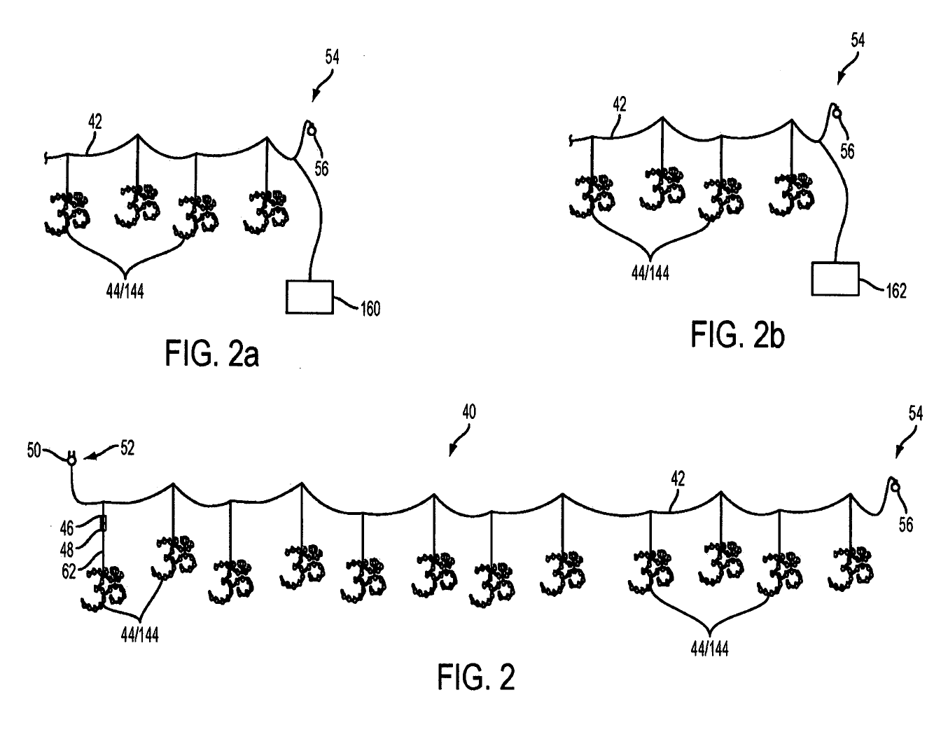

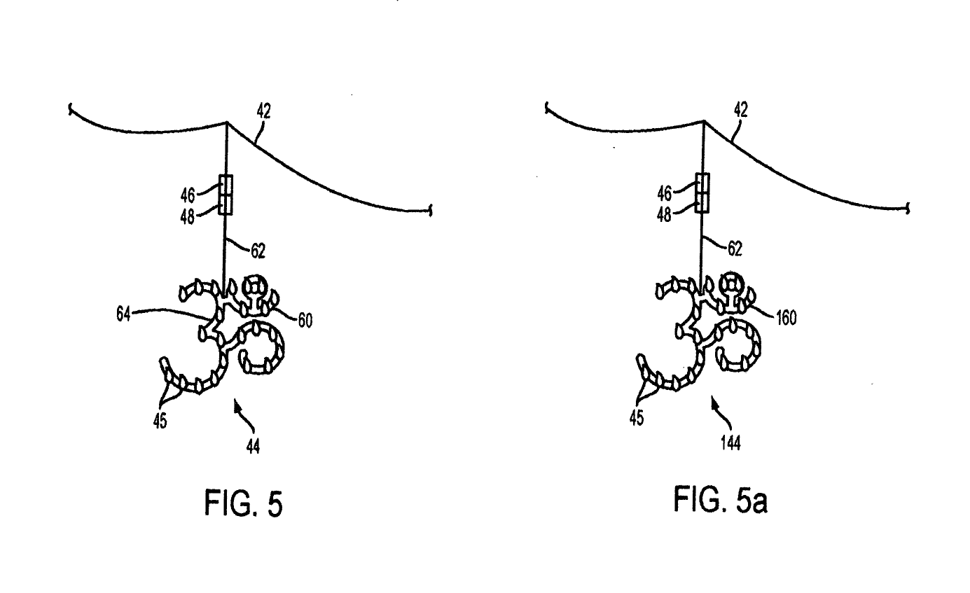

Referring now to FIG. 2, another illustrative embodiment of the Divali string of light Hindu Om syllable symbol and deya lamp arrangement 40 is shown, particularly arrangement 40 comprises an electrical supply string 42 capable of being connected to an electrical supply source and also electrically connected to light emitting lamp ornaments 44 or 144 which ornaments are discussed in detail in FIGS. 5, 5a, 9 and 10. Additionally, string 42 comprises an elongated insulated electrical wire which includes electrical connectors 46, 48 and feed wire 62 that are adapted to receive and supply electrical energy to light emitting ornaments 44 or 144. Also ornaments 44 or 144 are arranged in a spaced apart relationship along the electrical string 42 and although only one ornament 44 or 144 is shown in FIG. 2 as having connectors 46, 48 and feed wire 62, it is understood that each ornament 44 or 144 in the arrangement 40 is provided with such connectors and feed wires. Further arrangement 40 is shown in an elevated position and can be provided with various implements, e.g. hooks, hangers, etc. for attaching or hanging arrangement 40 from such a position.

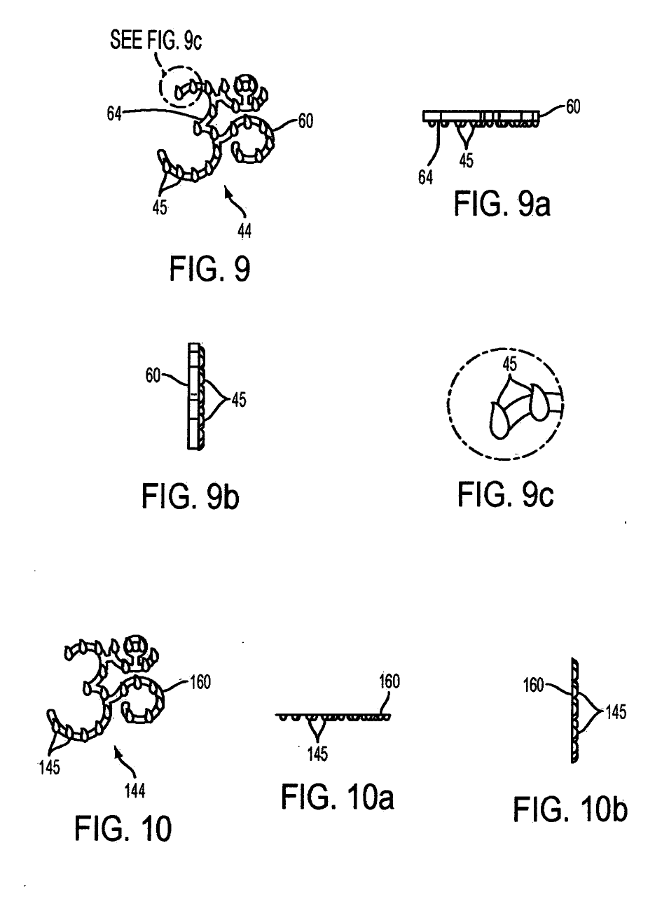

Still referring to FIG. 2, string 42 is provided at one end 52 with an attachment plug element 50 for effecting interconnection of the string 42 to a source of electricity and/or a another string of light emitting ornaments. Additionally, string 42 is provided with a second end 54 having an attachment plug 56 that is adapted to effect interconnection of string 42 to another string of light emitting ornaments having a similar attachment plug. Further referring to FIG. 2, string 42 is provided with a plurality of light emitting lamp ornaments 44 or 144 and according to the illustrative embodiment comprise ornaments in the likeness of the Hindu Om syllable symbol. The Om syllable symbol likeness ornament may consist of the ornament 44 described in FIGS. 5 and 9 or the ornament described and disclosed in FIGS. 5a and 10. Additionally, as previously described and disclosed, ornaments 44 or 144 are arranged at spaced apart intervals along string 42 and are individually electrically connected to string 42 via suitable connectors 46, 48 and feed wire 62.

FIG. 2a shows another embodiment of the Divali string of light Hindu Om syllable symbol and deya lamp arrangement 40 disclosed in FIG. 2 wherein an electrical battery source 160 is provided to supply electrical energy to string 42. The electrical battery source 160 may comprise any conventional commercial available devices and in this embodiment, attachment plug elements 50 and 56 would function to interconnect the string 42 to another or plurality of string of light emitting lamp ornaments. Alternatively, battery source 10 can be attached to plug elements 50 or 56.

FIG. 2b shows another embodiment of the Divali string of light Hindu Om syllable symbol and deya lamp arrangement 40 disclosed in FIG. 2 wherein a solar electrical source 162 is provided to supply electrical energy to string of light deya lamp arrangement 40. The solar electrical source 162 may comprise any conventional commercial available devices and in this embodiment, attachment plug elements 50 and 56 would function to interconnect the string 42 to another or plurality of string of light emitting ornaments. Alternatively, solar source 162 can be attached to plug elements 50 or 56.

Further, although FIGS. 1 and 2 disclose only ornaments 14, 154 and 44 and 144 respectively, said ornaments are constructed in such a manner that they can be mutually substituted for each other and interchanged such that arrangements 10 and 40 can comprise an array of ornaments 14, 154, 44, or 144 as desired and at the discretion of a user of the arrangements. Following this feature of the instant invention, for example, FIGS. 1, 1a, and 1b are shown with only ornaments 14 or 154 and FIGS. 2, 2a, 2b with only ornaments 44 or 144.

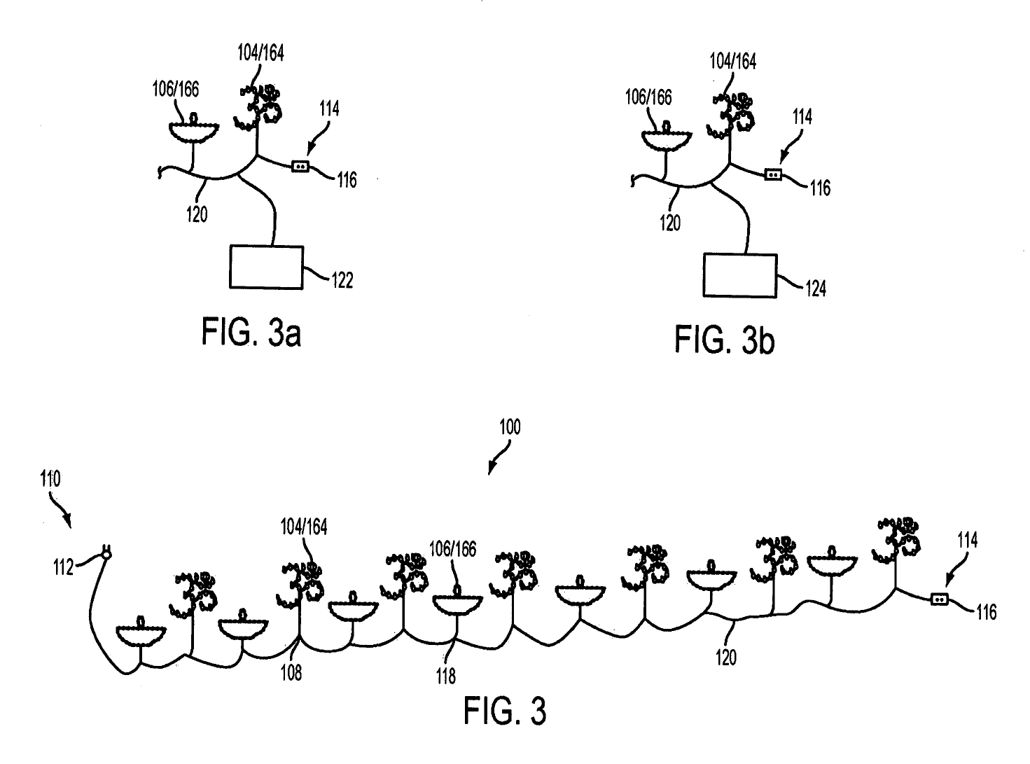

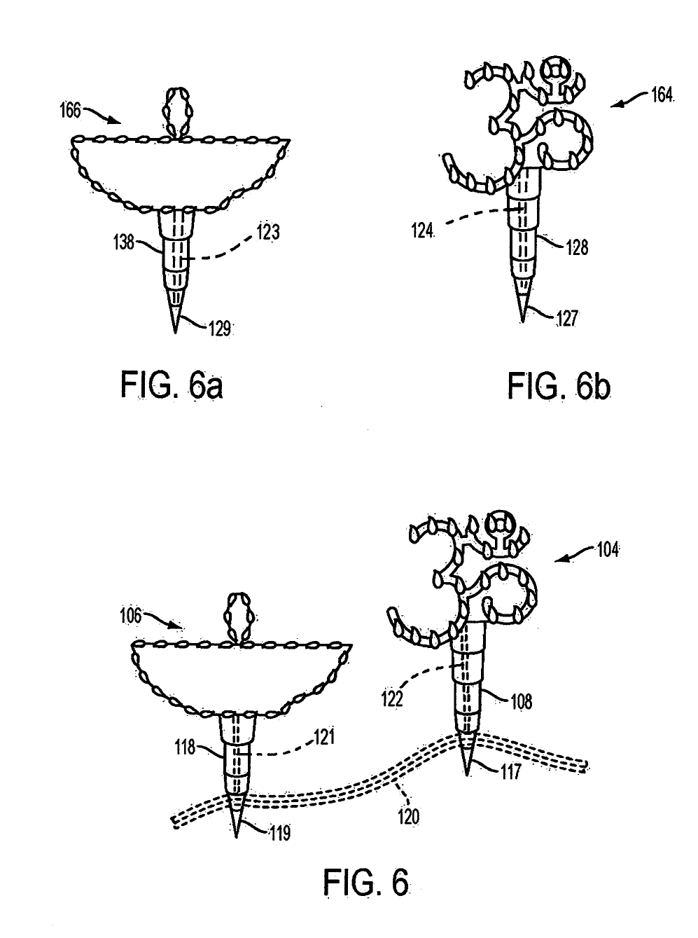

Now referring to FIG. 3, an another illustrative embodiment is shown of the Divali string of light Hindu. Om syllable symbol and deya lamp arrangement 100, capable of being connected to an electrical supply source, and wherein there is provided in a combined form of a light emitting ornament shown in the general shape of the deya lamp 106 or 166, similar to ornament 14 or 144 of FIG. 1, and a light emitting ornament in the general shape of the Hindu Om syllable symbol 104 or 164, similar to ornament 44 or 144 of FIG. 2. In FIG. 3, the light emitting ornament in the general shape of the deya lamp 106 or 166 includes a base element 118 and the light emitting ornament in the general shape of Hindu Om syllable symbol 104 or 164 includes base 108. The bases 118 and 108 may be constructed from any suitable rigid material that can support the ornaments 104, 164, 106 or 166 and can be molded or extruded from a transparent or suitable plastic material thereby utilizing a transparent or suitable plastic material which permits the integral connection of the light emitting components to the base material. Without limitation, the bases 118 and 108 may be constructed from composite materials, metals, metal alloys, plastics, or and like and as is further described and disclosed in FIGS. 6, 6a and 6b, the bases are constructed with ground penetrable ends 117, 119, 127 and 129. Further, in FIG. 3, although only a single ornament 104 or 164 is shown with a base 108, it is to be understood that each ornament 104 or 164 of the arrangement 100 is provided such a base; similarly, in FIG. 3, although only a single ornament 106 or 166 is shown with a base 118, it is to be understood that each ornament 106 or 166 of the arrangement is provided such a base. Further, although FIG. 3 discloses only a mixture of ornaments 104, 164, 106 and 166 respectively, said ornaments are constructed in such a manner that they can be mutually substituted or interchanged such that arrangement 100 can comprise any array of ornaments 104, 164, 106 and 166 as desired and at the discretion of a user of the arrangement.

Additionally, in the embodiment shown in FIG. 3, a series of lamp ornaments 104, 164, 106 or 166 are arranged at spaced intervals and are electrically connected by an electrical supply string 120 to an electrical power source. Electrical string 120 comprises an elongated insulated electrical wire has a one end 110 with an electrical plug 112 and a second end 114 having an electrical plug 116. Electrical plugs 112 and 116 facilitates the connection of connector 120 to an electrical power source at first end 110 and connection of the light emitting ornament lamp arrangement 100 to another string of light emitting ornament lamp arrangements.

Further in FIG. 3, deya likeness lamp ornaments 106 or 166 may consist of the deya lamp ornament 14 described and disclosed in further detail in FIG. 7 or be substituted with the deya lamp ornament 154 described and disclosed in further detail in FIG. 8. Likewise, the Hindu Om syllable symbol ornament 104 or 164 may consist of the Hindu Om syllable symbol ornament 44 described and disclosed in further detail in FIG. 9 or be substituted with the Hindu Om syllable symbol ornament 144 described and disclosed in further detail in FIG. 10.

FIG. 3a shows another embodiment of the Divali string of light Hindu Om syllable symbol and deya lamp arrangement 100 disclosed in FIG. 3 wherein an electrical battery source 122 is provided to supply electrical energy to arrangement 100. The electrical battery source 122 may comprise any conventional commercial available devices and in this embodiment, attachment plug elements 112 and 116 would function to interconnect the string 120 to another or a plurality of strings of light emitting ornaments. Alternatively, battery source 122 can be attached to plug elements 112 or 116.

FIG. 3b shows another embodiment of the Divali string of light Hindu Om syllable symbol and deya lamp arrangement 100 disclosed in FIG. 3 wherein a solar electrical source 124 is provided to supply electrical energy to arrangement 100. The solar electrical source 124 may comprise any conventional commercial available devices and in this embodiment, attachment plug elements 112 and 116 would function to interconnect the string 120 to another or plurality of strings of light emitting ornaments. Alternatively, solar source 124 can be attached to plug elements 112 or 116.

Now referring to FIG. 4, an illustrative embodiment of the light emitting deya lamp ornament 14 is shown in detail. As shown in further detail in FIG. 7, light emitting deya lamp ornament 14 is composed a series of electrically connected simulated tear drop shaped elements 34 which form a profile view likeness of a deya lamp having a simulated bowl shaped shell configuration with a simulated flame structure 32. Additionally, light emitting deya lamp ornament 14 is electrically connected to electrical wire 12 of FIG. 1, 1a, or 1b, by electrical feed wire 28 and electrical connectors 16 and 18. Also as shown in FIGS. 7, 7a and 7b, the light emitting deya lamp ornament 14, is provided with a backing 36 composed of plastic or plastic like material in which or onto which the simulated tear drop shaped elements 34 are electrically connected and mounted, bonded or otherwise secured. Finally, as shown in FIG. 7 electrical wiring 30 is provided on backing 36 to electrical connect elements 34.

Now referring to FIG. 4a, another embodiment of the light emitting deya lamp ornament 154 is shown in detail. As shown in further detail in FIG. 8, light emitting deya lamp ornament 154 is composed a series of simulated tear drop shaped elements 134 which form a profile view likeness of a deya lamp having a simulated bowl shaped shell configuration and a simulated flame structure 132. Also, as shown in FIGS. 8, 8a, and 8b, the light emitting deya lamp ornament 154 is provided with a backing 136 composed of wire or wire like material in which or onto which the simulated tear drop shaped elements 134 are electrically connected and mounted, bonded or otherwise secured. Further, backing 136 is likewise composed of material capable of electrically connecting elements 134. Additionally, light emitting deya lamp ornament 154 can be substituted for light emitting deya lamp ornament 14 and electrically connected to electrical wire 12 of FIG. 1, 1a, or 1b, by electrical connector 28, electrical connectors 16 and 18.

Now referring to FIG. 5, an illustrative embodiment of the light emitting Hindu Om syllable symbol ornament 44 is shown in detail. As shown in further detail in FIGS. 9, 9a, and 9b, ornament 44 is composed a series of electrically connected simulated tear drop shaped elements 45 which form a profile view likeness of a Hindu Om syllable symbol. Additionally, ornament 44 is electrically connected to electrical wire 42 of FIG. 2, 2a, or 2b, by an electrical wire feed 62 and electrical connectors 46, 48. Also, as shown in FIG. 9, the ornament 44 is provided with a backing 60 composed of plastic or plastic-like material in which or onto which the simulated tear drop shaped elements 45 are electrically connected and mounted, bonded or otherwise secured. Finally, as shown in Figure, electrical wiring 64 is provided on backing 60 to electrical connect elements 45.

Now referring to FIG. 5a, another embodiment of the light emitting Hindu Om syllable symbol ornament is shown in detail. Particularly, light emitting Hindu Om syllable symbol ornament 144 can be substituted for light emitting Hindu Om syllable symbol ornament 44 and be electrically connected to electrical wire 42 of FIG. 2, 2a, or 2b, by an electrical wire feed 62 and electrical connectors 46 and 48. As shown in further detail in FIG. 10, 10a, and 10b, ornament 144 is composed a series of electrically connected simulated tear drop shaped elements 45 which form a profile view likeness of a Hindu Om syllable symbol. Similarly, the ornament 144 is provided with a backing 160 composed of wire or wire-like material in which or onto which the simulated tear drop shaped elements 45 are electrically connected and mounted, bonded or otherwise secured. Backing 160 is likewise composed of material capable of electrically connecting elements 145.

Now referring to FIG. 6, the illustrative embodiment of the light emitting Hindu ornament in the profile likeness of a deya lamp and a light emitting ornament in the profile likeness of the Hindu Om syllable symbol shown in FIG. 3 is shown in detail. The light emitting ornament in the likeness shape of a deya lamp 106 includes a base element 118 and the light emitting ornament in the profile likeness of Hindu Om syllable symbol 104 includes base element 108. The base elements 108 and 118 may be constructed from any suitable rigid material that can support the light emitting lamp ornaments 104, or 106. Additionally, base elements 108, and 118 are structured on their bottom portions in a stake-like manner having sharp pointed bottom ends, 117, and 119, respectively, to facilitate and allow the light emitting lamp ornaments 104 or 106 to penetrate and be anchored into the ground. Without limitation, the base elements 117 and 118 may be constructed from composite materials, metals, metal alloys, plastics, or and like. Finally, base elements 117 and 118 are internally provided with electrical connectors 122 and 121 respectively capable of electrically connecting ornaments 104 and 106 with electrical supply string 120.

Now referring to FIG. 6a, a detailed view of the deya and Om syllable symbol lamp arrangement of FIG. 6 is shown with details of another embodiment of the deya likeness lamp arrangement. Particularly, the ornament 106 of FIG. 3 can be replaced or substituted with a deya likeness light emitting lamp ornament 166 which is a replicate of ornament 14 of FIG. 7 or the ornament 154 of FIG. 8. Additionally, ornament 166 includes a base element 138 which would consist of the same materials as base element 118; similarly, ornament 166 is also provided with a pointed end 129 similar to pointed end 119 of base element 118 to thereby allow deya light emitting lamp ornament 166 to penetrate and be anchored into the ground. Finally base element 138 is internally provided with electrical connector 123 capable of electrically connecting ornament 166 with an electrical power supply line similar to electrical power supply string 120 shown in FIGS. 3 and 6.

Now referring to FIG. 6b is a detailed view of the deya and Om syllable symbol lamp arrangement of FIG. 6 showing details of another embodiment of the Om syllable symbol lamp arrangement. Particularly, the ornament 104 of FIG. 3 can be replaced or substituted with an Om syllable symbol light emitting lamp ornament 164 which is a replicate of the ornament 44 shown in FIG. 9 or the ornament 144 shown in FIG. 10. Additionally, Om syllable symbol light emitting lamp ornament 164 includes a base element 128 which would consist of the same materials as base element 108; similarly ornament 166 is also provided with a pointed end 127 similar to pointed end 117 of base element 108 to thereby allow ornament 164 to penetrate and be anchored into the ground. Finally base element 128 is internally provided with electrical connector 124 capable of electrically connecting ornament 164 with an electrical power supply line similar to electrical power supply string 120 shown in FIGS. 3 and 6.

Now referring to FIGS. 7, 7a and 7b, the illustrative embodiment of the light emitting deya lamp ornament 14 of FIGS. 3 and 4 is shown in further detail. Referring now to FIG. 7, ornament 14 includes a series of electrically connected simulated tear drop shaped bulbs 34 which form a profile view likeness of a deya lamp having a simulated bowl shaped shell configuration and a simulated flame structure 32. Tear drop shaped bulbs 34 are illuminated by electricity and are electrically connectable to other similar tear drop shaped bulbs and may comprise an light emitting diode, an incandescent bulb, a neon bulb or any commercially available electrical illuminable fixture Ornament 14 is further provided with backing material 36 which if further described and disclosed in FIGS. 7a, 7b and 7c. Finally, electrical wiring 30, as shown in FIG. 7, is provided on backing 36 to electrical connect elements 34.

FIG. 7a is a top view of the ornament 14 of FIGS. 3 and 4 showing further details a backing 36 composed of plastic or plastic-like material in which or onto which the simulated tear drop shaped elements 34 are electrically connected and mounted, bonded or otherwise secured.

FIG. 7b is a side detailed view of the ornament 14 of FIGS. 3 and 4 showing further details particularly backing 36 composed of plastic or plastic-like material in which or onto which the simulated tear drop shaped bulbs 34 are electrically connected and mounted, bonded or otherwise secured.

Now referring to FIG. 7c is an exploded detailed view of the ornament 14 of FIG. 7 showing the orientation of simulated tear drop shaped bulbs 34 onto backing 36.

Now referring to FIGS. 8, 8a, and 8b, the embodiment of the light emitting deya likeness lamp ornament 154 of FIGS. 3, 3a, 3b, and 5 is shown in further detail. Particularly in FIG. 8, it is shown that ornament 154 includes a series of electrically connected simulated tear drop shaped bulbs 134 which form a profile view likeness of a deya lamp having a simulated bowl shaped shell configuration and a flame structure 132. Tear drop shaped bulbs 134 have the same configuration, illumination and electrical properties as simulated tear drop shaped bulbs 34 disclosed in FIGS. 7, 7a, and 7b; similarly tear drop shaped bulbs 134 are illuminated by electricity and are electrically connectable to other similar tear drop shaped bulbs and may comprise a light emitting diode, incandescent bulb, neon bulb or any commercially available electrical illuminable fixture. Additionally, FIG. 8 shows the orientation of simulated tear drop shaped bulbs 134 onto backing 136 which backing comprises wire or wire-like materials in which or onto which bulbs 134 are electrically connected and mounted, bonded or otherwise secured. Likewise, bulbs 134, shown in FIG. 8 are oriented onto backing 136 in the same orientation as bulbs 34 are oriented onto backing 36 shown in FIG. 7c.

FIG. 8a is a top view of the deya lamp ornament 154 showing backing 136 which backing comprises wire or wire-like material in which or onto which bulbs 134 are electrically connected, and mounted, bonded or otherwise secured.

FIG. 8B is a side detailed view of the ornament 154 showing further details particularly backing 136 composed of wire or wire-like material in which or to which the simulated tear drop shaped elements 134 are electrically connected and mounted, bonded or otherwise secured.

Now referring to FIGS. 9, 9a, 9b and 9c the illustrative embodiment of the light emitting lamp ornament in the general shape of the Hindu Om syllable symbol 44 of FIGS. 2, 2a, and 2b is shown in further detail. Particularly, in FIG. 9, it is shown that ornament 44 is provided with numerous light emitting elements electrically connected simulated tear drop shaped bulbs 45; also simulated tear drop shaped bulbs 45 have the same configuration, illumination and electrical properties as simulated tear drop shaped bulbs 34 disclosed in FIGS. 7, 7a, and 7b. Additionally, tear drop shaped bulbs 45 are illuminated by electricity and are electrically connectable to other similar tear drop shaped bulbs and may comprise light emitting diodes, incandescent bulbs, neon bulbs or any commercially available electrical illuminable fixtures. Similarly, ornament 44 is provided with a backing 60 composed of plastic or plastic like material in which or onto which the simulated tear drop shaped bulbs 45 are mounted, bonded or otherwise secured and electrical conducting material 64 capable of electrically interconnecting bulbs 45.

Now referring to FIG. 9a is a top detailed view of the ornament 44 lamp of FIG. 9 further showing the orientation of simulated tear drop shaped bulbs 45 to the backing 60 and electrical conducting material 64.

FIG. 9b shows a side view FIG. 9 of the ornament 44 and the associated tear drop bulbs 45 and the backing 60 composed of plastic or plastic like material in which or on which the simulated tear drop shaped bulbs 45 are electrically connected and mounted, bonded or otherwise secured.

Now referring to FIG. 9c is an exploded detailed view of the ornament 44 of FIG. 9 showing the orientation of tear simulated tear drop shaped bulbs 45 onto backing 60.

FIG. 10 is a detailed view of the lamp arrangement of FIG. 2, 2a, 2b, showing further details of another embodiment of the Hindu Om syllable symbol lamp ornament. Particularly, in FIG. 10, ornament 144 is provided with numerous electrically connected light emitting elements simulated tear drop shaped bulbs 145. Simulated tear drop shaped bulbs 145 have the same configuration, illumination and electrical properties as simulated tear drop shaped bulbs 34 disclosed in FIGS. 7, 7a, and 7b. Tear drop shaped bulbs 145 are illuminated by electricity and are electrically connectable to other similar tear drop shaped bulbs and may comprise light emitting diodes, incandescent bulbs, neon bulbs or any commercially available electrical illuminable futures. Similarly, ornament 144 is provided a backing 160 composed of wire or wire-like material in which or onto which the simulated tear drop shaped bulbs 45 are electrically connected and mounted, bonded or otherwise secured. Additionally, FIG. 10 shows that the orientation of simulated tear drop shaped bulbs 145 onto backing 160 is similar to the orientation of simulated tear drop shaped bulbs 45 to backing 60 as shown in FIG. 9c.

FIG. 10a is a top detailed view of FIG. 10 showing the ornament 144 and the associated bulbs 145 and backing 160 composed of wire or wire-like material in which or onto which the bulbs 145 are electrically connected and mounted, bonded or otherwise secured.

FIG. 10b is a side view of FIG. 10 showing the ornament 144 and the orientation of associated bulbs 145 onto backing 160 composed of wire or wire-like material in which or onto which the bulbs 145 are electrically connected and mounted, bonded or otherwise secured.

As previously stated, the above described and disclosed embodiments of the Divali string of light Om syllable and deya lamp arrangement may include other variations. For example, although will now be described in further detail with reference to the drawing Figures It should be noted that the following described and disclosed Divali string of light Om syllable symbol and deya lamp arrangement may have more embodiments than those shown in the drawing Figures and shall include all variations and modifications within the scope of the claims.

What is claimed:

1. An electrically powered ornamental lamp arrangement for interior or exterior lighting display comprising:
an electrical supply string and
at least one electrically wired religious symbol ornament electrically and detachably connected to said supply string and
wherein said ornament includes at least one light emitting element electrically connected to said electrical supply string.

2. An electrically powered ornamental lamp arrangement for interior or exterior lighting display of claim 1 further wherein:
at least one ornament is constructed in the likeness of the Hindu Om syllable symbol for display in celebration of the Hindu Divan light holiday.

3. An electrically powered ornamental lamp arrangement for interior or exterior lighting display of claim 2 wherein
at least one ornament is constructed in the likeness of a Hindu deya lamp and further wherein said ornament in the likeness of the Hindu Om syllable symbol and said ornament in the form of a Hindu deya lamp are capable of being substituted for each other to thereby create an array of ornaments as desired.

4. An electrically powered ornamental lamp arrangement for interior or exterior lighting display of claim 3 further wherein said Hindu deya lamp ornament includes a simulated bowl shaped shell having a simulated flame structure.

5. An electrically powered ornamental lamp arrangement for interior or exterior lighting display of claim 4 further wherein:
said electrical supply string is electrically connectable to a source of electrical energy and further wherein
said Hindu Om syllable symbol ornament and said Hindu deya lamp ornament contain light emitting elements and further wherein said ornaments include backings which are electrically connectable to said electrical supply string by electrical connectors and an electrical feed wire.

6. An electrically powered ornamental lamp arrangement for interior or exterior lighting display of claim 5 further wherein said backings of said ornaments are capable of electrically interconnecting said light emitting elements with other light emitting elements located on the respective ornaments and further wherein said backings comprise plastic or plastic-like material provided with electrical conducting material and optionally the plastic or plastic-like material can comprise wire or wire-like material capable of electrically interconnecting said light emitting elements.

7. An electrically powered ornamental lamp arrangement for interior or exterior lighting display of claim 6 wherein each of said light emitting elements are in the shape of a tear.

8. An electrically powered ornamental lamp arrangement for interior or exterior lighting display of claim 7 wherein said light emitting elements in the shape of a tear comprise a light emitting diodes.

9. An electrically powered ornamental lamp arrangement for interior or exterior lighting display of claim 8 further wherein a plurality of said ornaments are provided and said ornaments are arranged at spaced intervals.

10. An electrically powered ornament lamp arrangement for interior or exterior lighting display of claim 9 wherein at least one ornament is electrically connected to said electrical supply string wherein said electrical string has a first end which terminates in an first electrical attachment plug and a second end which ends in a second electrical attachment plug.

11. An electrical powered ornament lamp arrangement for interior or exterior lighting display of claim 10 wherein said electrical plugs are capable of connecting said electrical string to a source of electrical power at the first end and electrically connect said arrangement to a second electrical powered ornament lamp arrangement.

12. An electrical powered ornament lamp arrangement for interior or exterior lighting display of claim 11 wherein
said source of electrical power optionally comprises an electrical battery and further wherein optionally said source of electrical power comprises a solar energy supply.

13. An electrically powered ornament lamp arrangement for interior or exterior lighting display of claim 12 further wherein said arrangement is provided with means for attaching said arrangement in an elevated manner.

14. An electrically powered ornamental lamp arrangement for interior or exterior lighting display of claim 12 further wherein
said ornament constructed in the likeness of the of Hindu Om syllable symbol includes an elongated base element and further wherein
said ornament constructed in the likeness of a Hindu deya further includes an elongated base element.

15. An electrically powered ornamental lamp arrangement for interior or exterior lighting display of claim 14 further wherein
said elongated base elements are constructed of suitable rigid material capable of supporting their respective ornaments.

16. An electrically powered ornamental lamp arrangement for interior or exterior lighting display of claim 15 wherein said elongated base elements are structured in a stake-like manner with sharp pointed bottom portions to facilitate and allow said ornaments to be placed and anchored into the ground.

17. An electrically powered ornamental lamp arrangement for interior or exterior lighting display of claim 16 wherein said elongated base elements are internally provided with an electrical connectors capable of electrically connecting said ornaments to an electrical power supply.

18. An electrically powered ornamental lamp arrangement for interior or exterior lighting display of claim 17 wherein said ornaments are electrically connectable to another electrically powered ornamental lamp arrangement for display in celebration of the Hindu Divali light holiday.

19. An electrically powered ornamental lamp arrangement for interior or exterior lighting display comprising:
an electrical supply string and
a light emitting ornament in the likeness of the Hindu Om syllable symbol and further wherein
said light emitting ornament in the likeness of the Hindu Om syllable symbol includes connectors and an electrical feed wire and further wherein
said arrangement includes a plurality of ornaments in the likeness of the Hindu Om syllable symbol and further wherein each ornament in the likeness of the Hindu Om syllable symbol includes a plurality of light emitting elements electrically connected to said supply string via said connectors and electrical feed wire and further wherein each light emitting element comprises a light emitting diode having a tear drop shape and further wherein
an ornament in the likeness of the Hindu Om syllable symbol is provided with a backing of plastic or plastic-like material wherein said backing is provided with electrical material capable of electrically interconnecting said light emitting elements and further wherein said backing for said ornament can be substituted with wire or wire-like material wherein said wire or wire-like material is capable of electrically interconnecting said light emitting elements and further wherein
any ornament in the likeness of the Om syllable symbol herein may be substituted by a light emitting ornament in the likeness of a Hindu deya lamp wherein said Hindu deya lamp ornament includes electrical connectors and an electrical feed wire and further including each substitute Hindu deya lamp ornament includes a plurality of light emitting elements electrically connected to said supply string via said Hindu deya lamp ornament connectors and electrical feed wire and further wherein each light emitting element of said Hindu deya lamp ornament comprises a light emitting diode having a tear drop shape, and further wherein said substitute Hindu deya lamp ornament is provided with a backing of plastic or plastic-like material and which backing is provided with electrical material capable of electrically interconnecting said substitute Hindu deya lamp ornament light emitting elements and further wherein said backing for said substitute Hindu deya lamp ornament can be substituted with wire or wire-like material which wire or wire-like material which is capable of electrically interconnecting said light emitting elements of said Hindu deya lamp ornament and further wherein
each ornament in the likeness of a Hindu deya lamp and each ornament in the shape of the Hindu Om syllable symbol are capable of being substituted for each other to thereby create an array of ornaments as desired and further wherein
a plurality of said ornaments are arranged at spaced intervals and further wherein
said arrangement is provided with means for attaching said arrangement in an elevated manner and further wherein
said ornaments are electrically connected to said electrical supply string and further wherein said electrical string has a first end which terminates in an electrical plug and a second end which terminates in an electrical plug and further
wherein said electrical plugs are capable of connecting said string to a source of electrical power source at said first end and connecting one or more said ornaments at the second end to a second electrically powered ornamental lamp arrangement and further wherein
said source of electrical power can optionally comprise an electrical battery and further wherein said source of electrical power can optionally comprise a solar energy supply for interior or exterior lighting display for display in celebration of the Hindu Divali light holiday.

20. An electrically powered ornamental lamp arrangement for interior or exterior lighting display comprising:
a electrical supply string and
a light emitting ornament in the likeness of a Hindu deya lamp and further wherein
said light emitting ornament in the likeness of a Hindu deya lamp includes an elongated base element and further including
a light emitting ornament in the likeness of the Hindu Om syllable symbol and further wherein
said light emitting ornament constructed in the likeness of the of Hindu Om syllable symbol includes an elongated base element and further wherein
said arrangement includes a plurality of light emitting ornaments in the likeness of a Hindu deya lamp and further wherein each ornament in the form of a Hindu deya lamp includes a plurality of light emitting elements electrically connected to said supply string and further wherein each said light emitting element comprises a light emitting diode having a tear drop shape and further wherein,
said arrangement includes a plurality of ornaments in the likeness of the Hindu Om syllable symbol and further wherein each ornament in the likeness of the Hindu Om syllable symbol includes a plurality of light emitting elements electrically connected to said supply string and further wherein each light emitting element of said Hindu Om syllable symbol ornament comprises a light emitting diode having a tear drop shape, and further wherein
each ornament in the likeness of a Hindu deya lamp and each ornament in the likeness of the Hindu Om syllable symbol is provided with a backing of plastic material and which backing is provided with electrical material capable of electrically interconnecting said light emitting elements and further wherein said backings for said ornament can be substituted with wire or wire-like material which wire or wire-like material is capable of electrically interconnecting said light emitting elements and further wherein
each ornament in the likeness of a Hindu deya lamp and each ornament in the likeness of the Hindu Om syllable symbol is capable of being substituted for each other to thereby create an array of ornaments as desired and further wherein
said elongated base elements are constructed of rigid material capable of supporting their respective ornaments and further wherein said elongated base elements are provided with a internal electrical connectors capable of electrically connecting each ornament with said electrical supply string and further wherein
said elongated base elements are structured in a stake-like manner with a sharp pointed bottom ends to facilitate and allow said ornaments to be placed and anchored into the ground and further wherein
a plurality of said ornaments are arranged at spaced intervals and further wherein
said ornaments are electrically connected to said electrical supply string and further wherein said electrical string has a first end which terminates in an electrical plug and a second end which terminates in an electrical plug and further wherein
said electrical plugs are capable of connecting said string to a source of electrical power source at said first end and connecting one or more said ornaments at the second end to a second electrically powered ornamental lamp arrangement and further wherein
said source of electrical power can optionally comprise an electrical battery and further wherein said source of electrical power can optionally comprise a solar energy supply for interior or exterior lighting display for display in celebration of the Hindu Divali light holiday.
